(19) United States
(12) Patent Application Publication
(10) Pub. No.: US 2010/0089601 A1
(43) Pub. Date: Apr. 15, 2010

(54) Power tool having an illuminated torque calibration indicator

(76) Inventors: Masatoshi Fukinuki, Nanjing (CN); Gan Wei, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/586,984

(22) Filed: Sep. 30, 2009

(30) Foreign Application Priority Data
Oct. 9, 2008 (CN) 200820161628.X

(51) Int. Cl. B23B 45/00; B23B 47/14

(52) U.S. Cl. 173/20; 173/47

(57) ABSTRACT

A power tool including a housing, a motor, a transmission, a handle, an adjustable torque clutch, wherein at least a portion of the torque clutch is illuminated. Illumination of the torque clutch permits the user to identify the work mode or torque value of the torque clutch clearly in all working conditions, including dimly lit conditions.

### CROSS-REFERENCE TO RELATED APPLICATIONS

This application claims priority under 35 U.S.C. 119 to CN 200820161628.X filed Oct. 9, 2008, and is hereby incorporated by reference.

### FEDERALLY SPONSORED RESEARCH OR DEVELOPMENT

Not Applicable.

### TECHNICAL FIELD

The present invention relates to a power tool, and more particularly, to an illuminate torque clutch for a power tool.

### BACKGROUND OF THE INVENTION

Generally, the torque of a standard power tool can be adjusted through a rotatable torque clutch. A numerical scale is typically provided on the torque clutch to indicate the level of torque. For example, a typical power tool as shown in FIG. 1 may have several different work modes and torque options. This power tool has a torque clutch having a scale 24, wherein the scale 24 is composed of a set of numbers 23 and an indicator 25. The housing of the scale 24 is transparent so the numbers can be seen while the torque clutch is rotated to the desired position. Alternatively, the numbers may be brightly colored.

When the operating environment is dark, the user may have difficulty identifying the numbers of the scale 24, and may choose an undesired work mode or torque. Misoperation and damage of the workpiece may result if the wrong level of torque is being used on an inappropriate piece of material.

Typically, a power tool includes a work light. The work light is typically placed on the housing of the power tool and under the torque chuck, which is facing the workpiece. An ON/OFF trigger may be used to turn the work light on and off. The work light illuminates the workpiece in front of the power tool when the operating environment is dark.

However, the work light can only illuminate a small area in front of the power tool, because the work light faces the workpiece and usually uses an LED which may not be bright enough. Therefore, it is not easy for the user to choose the desired work mode or adjust the torque of the power tool in a dimly lit environment, because the work light, in view of its placement, is not able to illuminate on the torque clutch. Thus, the user may chose the incorrect work mode and/or the torque setting, resulting in misoperation and possible damage to the workpiece.

The present invention overcomes the disadvantages of the prior art by providing a power tool having an illumination means. The illumination means permits the user to read and set the proper torque and work setting of the power tool even in dimly lit situations.

### SUMMARY OF THE INVENTION

The present invention provides a power tool which can be used in any lighting conditions, including dimly lit environments. The power tool includes a housing, a motor, a transmission arrangement, a handle, and an adjustable torque clutch, wherein the torque clutch is illuminated by a light source. Preferably, the light source is located inside the power tool, and the torque clutch is constructed of a transparent material. Alternatively, the torque clutch is illuminated by a fluorescent or light absorbing and reflective material.

### BRIEF DESCRIPTION OF THE DRAWINGS

Additional advantages and features of the present invention will become apparent from the subsequent description and the appended claims, taken in conjunction with the accompany drawings, wherein:

FIG. 1 is a top view of a torque clutch of a typical power tool;

FIG. 2 is a perspective view of a power tool constructed in accordance with the teachings of the present invention;

FIG. 3 is an enlarged view of the torque clutch according to a first embodiment;

FIG. 4 is another enlarged view of the torque clutch according to a first embodiment;

FIG. 5 is a sectional view of the torque clutch of FIG. 2;

FIG. 6 is an enlarged view of the torque clutch according to a second embodiment;

FIG. 7 is a sectional view of the torque clutch of FIG. 6.

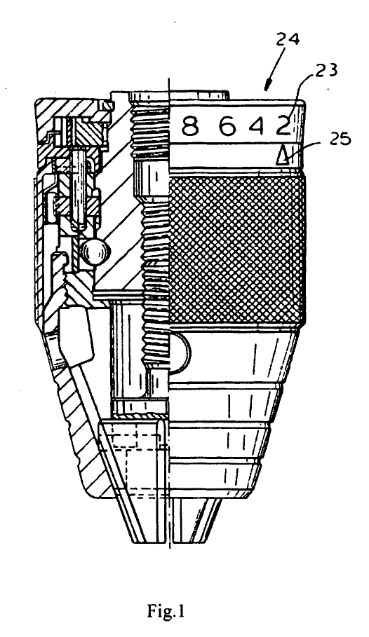

### DETAILED DESCRIPTION

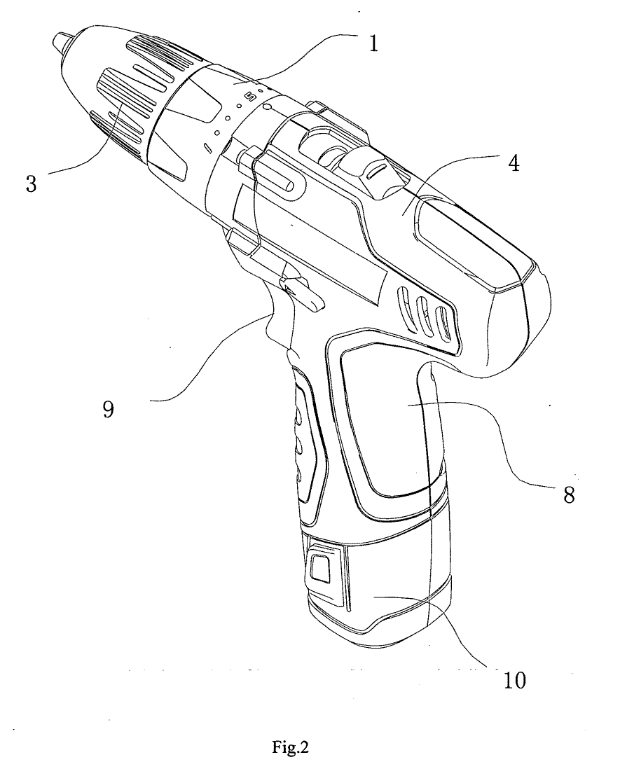

With reference to FIG. 2, a power tool constructed in accordance with the teachings of the present invention comprises a housing 4 containing a motor (not shown), and a handle 8 with a trigger assembly 9 mounted thereon. A battery 10 is detachably mounted on the bottom of the handle 8. A chuck 3 is disposed in front of the housing 4. A bit (not shown) is generally coaxial with the motor, which is detachably attached to the chuck 3 and is driven by the motor. A rotatable torque clutch 1 is supported on the housing 4, and positioned between the chuck 3 and the housing 4.

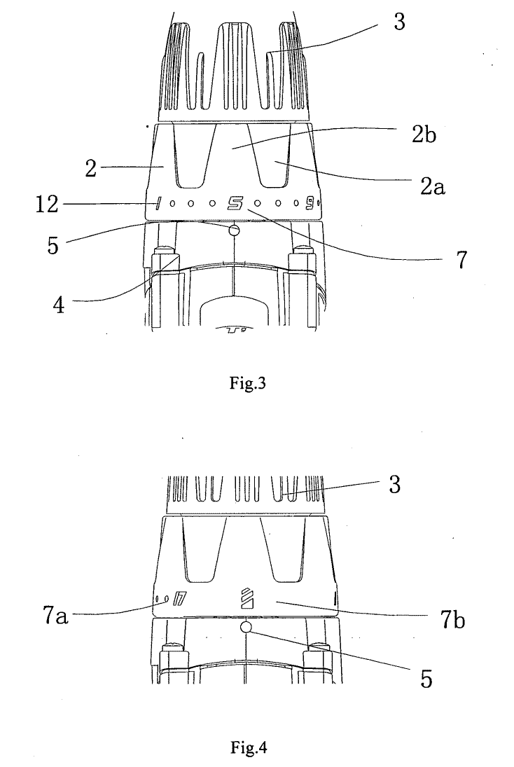

As shown in FIG. 3 to FIG. 6, the torque clutch 1 is formed in one piece. The torque clutch includes a scale portion 7 close to one end of the housing 4. As shown in FIG. 4, the scale portion 7 includes a work mode scale portion 7a and a torque setting scale portion 7b, which are used to set the tool on the appropriate work mode or torque level for the project. Numbers and the marks on the scale portion 7 form the scale 12. Several depressed elements 2a are evenly spaced and separated by raised elements 2b, and arranged at intervals on the torque clutch 1, forming a grip portion 2. This grip structure increases the contact area of the hand and the grip portion 2 providing better grip when the user holds and rotates the torque clutch 1 to the desired position.

In the present embodiment, the torque clutch 1 is preferably constructed from transparent material, including, for example, any suitable plastic. The external surface of torque clutch 1 may covered by opaque coating, while the scale 12 remains transparent. Optionally, the scale 12 is covered by opaque coating, and the area surrounding the scale is transparent. The opaque coating on the torque clutch or scale may be a paint, lacquer, or film. The opaque coating or film may cover the external surface or inner surface of the torque clutch 1. Alternatively, the numbers and marks of the scale 12 may be cut out or hollowed.

As shown in FIG. 3, there is an indicator 5 on the housing 4, which may be any suitable two-dimensional shape, transparent or cut out. The midline of the indicator 5 and the axial symmetrical axis of the power tool are in the same plane. The indicator 5 meets at the scale 12 on the torque clutch 1, thereby designating the work mode or torque value of the power tool when the torque clutch is rotated to the desired setting.

In order to illuminate the numbers and/or marks of the scale, preferably a light source 6 is mounted within the housing 4, positioned opposed to the indicator 5. In an alternative embodiment, the light source 6 may be mounted within the torque clutch 1, which is positioned opposed to the scale 12 of torque clutch 1. The light source 6 may any suitable light source for use within a power tool. Preferably, the light source is an LED.

In FIG. 5, the light source 6 is triggered by the trigger assembly 9 for controlling the motor operating the power tool. The light source 6 is lit when the user presses the trigger assembly 9 and the power tool is turned on for use. The light source 6 then illuminates the numbers and/or marks of the scale 12 clearly indicating the work mode or the torque setting of the power tool when the operating environment is dark or dimly lit.

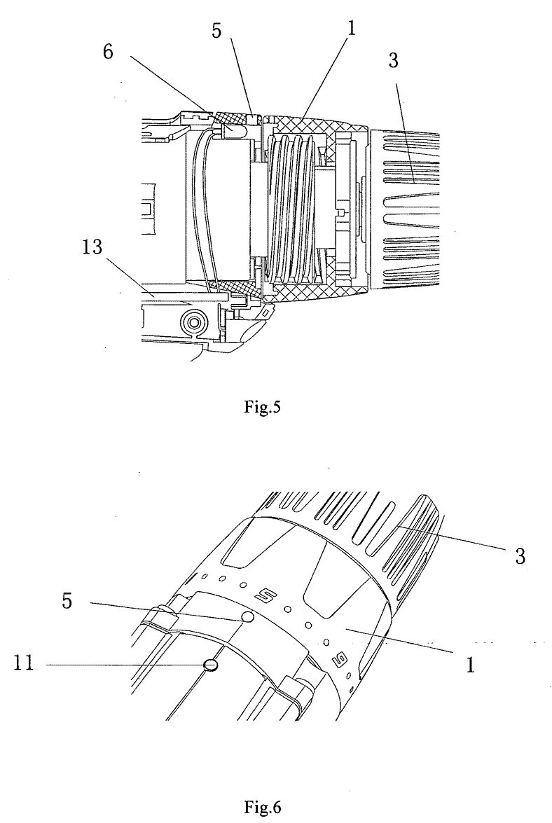

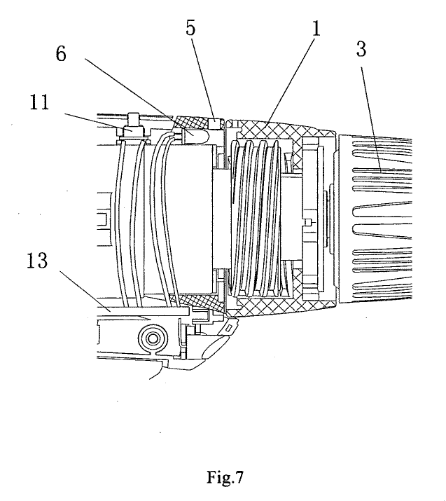

FIG. 6 and FIG. 7 show a second embodiment of the present invention, wherein the housing 4 includes a button 11, which is connected with the light source 6 by an electrical connection or printed circuit board 13. The light source 6 will be lit by the user pressing the button 11. Again, the light source 6 is useful for clearly reading the gradients for the work mode or the torque setting on the torque clutch 1.

In yet another possible embodiment, rather than having a light source mounted in the housing 4, the scale 12 and the indicator 5 may be covered by a light-absorbing, self illuminating coating. The alternative illumination source may also include a fluorescent or reflective material or paint. The torque clutch is illuminated when the tool is placed in a high light environment. The scale 12 of torque clutch 1 shines or reflects absorbed light, providing the user with the ability to read the work mode and torque level indicators when using the power tool in dimly lit or dark working conditions.

What is claimed is:

1. A power tool comprising:
a housing;
a motor;
a transmission means;
a handle;
an adjustable torque clutch;
wherein at least a portion of the torque clutch is illuminated.

2. The power tool of claim 1, wherein the torque clutch further includes a torque setting indicator.

3. The power tool of claim 2, wherein the torque setting indicator includes a plurality of numbers.

4. The power tool of claim 1 further including a light source.

5. The power tool of claim 4, wherein the light source is an LED.

6. The power tool of claim 4, wherein the light source is located within one of the housing and the torque clutch.

7. The power tool of claim 5, wherein the light source is located beneath the torque setting indictor.

8. The power tool of claim 1, wherein at least a portion of the torque clutch is covered by a light-absorbing, reflective material.

9. The power tool of claim 1, wherein the illuminated portion of the torque clutch includes a torque setting scale.

10. The power tool of claim 1, wherein the illuminated portion of the torque clutch includes a work mode selector.

11. A power tool comprising:
a housing having a motor and a transmission; and,
an adjustable torque clutch having a torque selection indicator, wherein at least a portion of the torque clutch is illuminated.

12. The power tool of claim 11, wherein the torque indicator includes a plurality of numbers and marks.

13. The power tool of claim 11, wherein one of the housing and the torque clutch further includes an interior light source.

14. The power tool of claim 13, wherein the light source is located beneath the torque indicator.

15. The power tool of claim 11, wherein the torque indicator is covered by a light-absorbing, reflective material.
